(19) United States
(12) Patent Application Publication
(10) Pub. No.: US 2010/0177501 A1
(43) Pub. Date: Jul. 15, 2010

(54) BACKLIGHT MODULE FOR A SCANNING BACKLIGHT LCD

(76) Inventors: Chi-Hsiu Lin, Yun-Lin Hsien (TW); Wei-Wen Chung, Taoyuan County (TW); Shih-Hen Chao, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/426,292

(22) Filed: Apr. 20, 2009

(30) Foreign Application Priority Data
Jan. 13, 2009 (TW) 098101028

(51) Int. Cl. G09F 13/08

(52) U.S. Cl. 362/97.3

(57) ABSTRACT

A backlight module includes a fluorescent lamp, an LED module, a controller, a lamp inverter, and an LED driver. The controller generates a first control signal and a second control signal according to a display signal. The lamp inverter drives the fluorescent lamp according to the first control signal. The LED driver drives the LED module according to the second control signal. The LED module is installed close to the fluorescent lamp for compensating the luminance of the fluorescent lamp when turning on and turning off.

### BACKGROUND OF THE INVENTION

1. Field of the Invention

The present invention is related to a backlight module of an LCD, and more particularly, to a backlight module utilizing an LED module to compensate the luminance of the fluorescent lamp of the backlight when the fluorescent lamp is turned on and turned off.

2. Description of the Prior Art

Since a conventional backlight module of an LCD has the fixed luminance unvaried with time, the conventional backlight module of an LCD is prone to the issue of motion blur. A scanning backlight module is then derived to solve this problem. Please refer to FIG. 1. FIG. 1 is a diagram illustrating a conventional scanning backlight module of an LCD. As shown in FIG. 1, an LCD panel 110 comprises three scanning sections 112, 114 and 116 and each scanning section corresponds to its own lamps 120 as the backlight source. The method for driving a conventional scanning backlight module of an LCD is described as below: in a first operation instance, the lamps 120a and 120b corresponding to the scanning section 112 are turned on, while the rest of the lamps are turned off; in the second operation instance, the lamps 120c and 120d corresponding to the scanning section 114 are turned on, while the rest of the lamps are turned off; in the third operation instance, the lamps 120e and 120f corresponding to the scanning section 116 are turned on, while the rest of the lamps are turned off; the above operation sequences are then repeated. For each scanning section, the display mechanism described above during a frame time is equivalent to inserting a blank frame so that the motion blur issue can be improved.

Please refer to FIG. 2. FIG. 2 is a diagram illustrating the signal waveforms of a conventional scanning backlight module of an LCD. As shown in FIG. 2, the signal S1 represents the control signal of the backlight module, the period D represents the duty cycle of the signal S1, the frequency F represents the frequency of the signal S1, the signal IL represents the operating current of the lamp, the signal LS represents the luminance of the lamp, the duration Tr represents the luminance rising time, and the duration Tf represents the luminance falling time. The on/off operation of the backlight module is controlled by the signal S1 and the ratio of the backlight module being turned on/off is determined by the duty cycle D. When the backlight module is turned on by the signal S1, the lamp requires the duration Tr to reach the stable luminance, and when the backlight module is turned off by the signal S1, the lamp is darkened after the duration Tf. Due to the relatively long luminance rising/falling time required by the lamp, the effect of using the black frame insertion method to improve the motion blur issue is limited.

As mentioned above, the driving method of the scanning backlight module of an LCD does not turn on all of the lamps 120 simultaneously, so the overall luminance of the LCD is lower than that of the LCD with the conventional backlight module. For example, as shown in FIG. 1, the overall luminance and power consumption of the LCD with a scanning backlight module are approximately one third of the overall luminance and power consumption of the LCD with the conventional backlight module.

For improving the degraded overall luminance of the LCD with the scanning backlight module, a solution is to increase the luminance of the lamps 120. Increasing the luminance of the lamps 120, however, means the lamps 120 must be driven with a higher electric condition (a greater lamp current for example), and consequently decreasing the lifetime of the lamps.

### SUMMARY OF THE INVENTION

The present invention provides a backlight module. The backlight module comprises a first light source, a second light source, a controller, a first light driver and a second light driver. The second light source is installed close to the first light source, for compensating a luminance of the first light source when the first light source is turned on and turned off. The controller is for generating a first control signal and a second control signal according to a display signal. The first light driver is electrically connected to the first light source, for driving the first light source according to the first control signal. The second light driver is electrically connected to the second light source, for driving the second light source according to the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional scanning backlight module of an LCD.

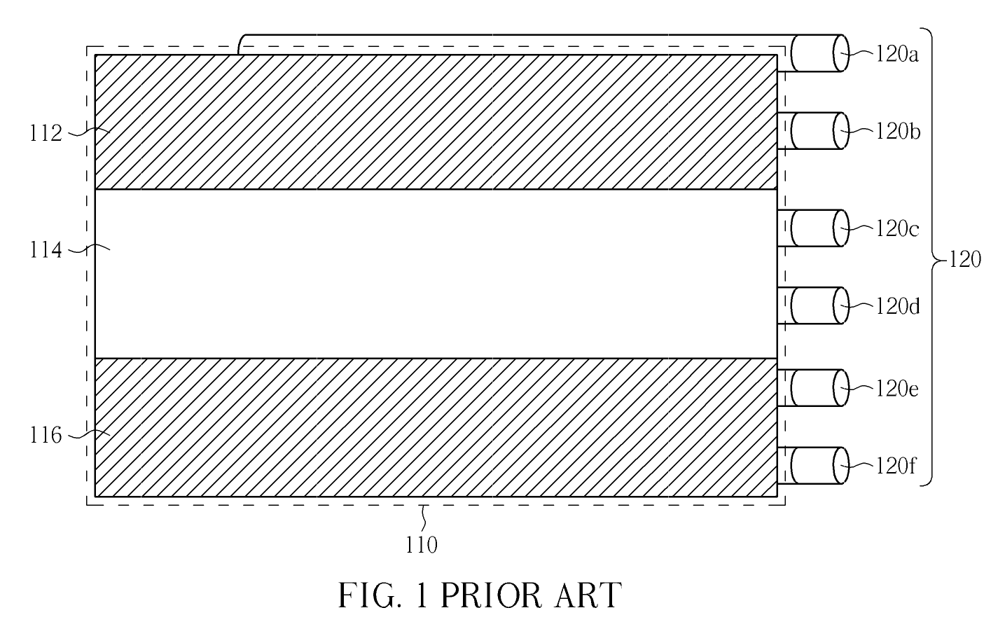

FIG. 2 is a diagram illustrating the signal waveforms of a conventional scanning backlight module of an LCD.

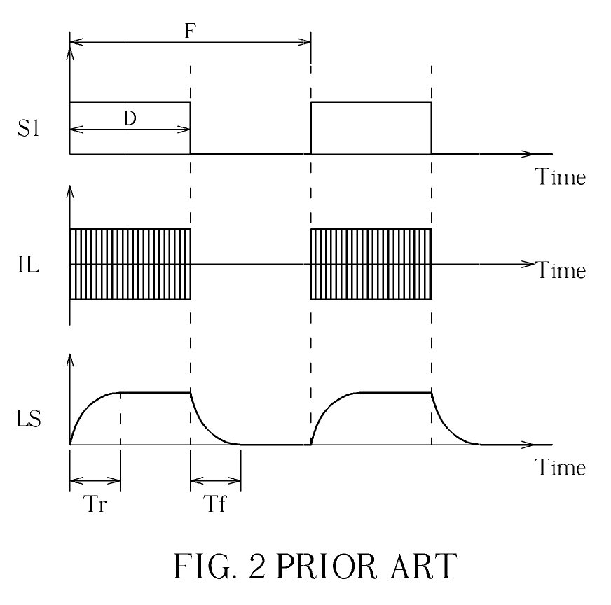

FIG. 3 is a block diagram illustrating the backlight module of the present invention.

FIG. 4 is a diagram illustrating the location of the fluorescent lamp and the LED module in the backlight module.

FIG. 5 is a waveform diagram illustrating the control signals of the first embodiment of the backlight module of the present invention.

FIG. 6 is a waveform diagram illustrating the control signals of the second embodiment of the backlight module of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is coupled to another device, that connection may be through a direct electrical connection, or through an indirect electrical connection via other devices and connections.

In general, the fluorescent lamps of the backlight module of an LCD comprise hot cathode fluorescent lamps (HCFLs) and cold cathode fluorescent lamps (CCFLs). Taking the CCFL as an example, to decrease from 90% to 30% of the relative luminance approximately requires 3 ms; to increase from 10% to 90% of the relative luminance approximately requires 3 ms; to decrease from 100% to 0% of the relative luminance approximately requires 10 ms; and to increase from 0% to 100% of the relative luminance approximately requires 10 ms. The CCFL requires a relatively longer luminance rising/falling time (i.e. slow luminance response), so the effect of improving motion blur is limited when the CCFL is utilized in the method of black frame insertion of the scanning backlight module. By making use of the property of the slow luminance response time of the lamps of the backlight source, the backlight module of the present invention turns on the lamps of the backlight source again while the luminance of the lamps of the backlight source is not fully diminished, and on the contrary, the backlight module of the present invention turns off the lamps of the backlight source again while the lamps of the backlight source is still rising for full luminance. Therefore, the backlight module can maintain a certain level of luminance during the black frame insertion, for improving the issues of luminance insufficiency and flicker of the black frame insertion.

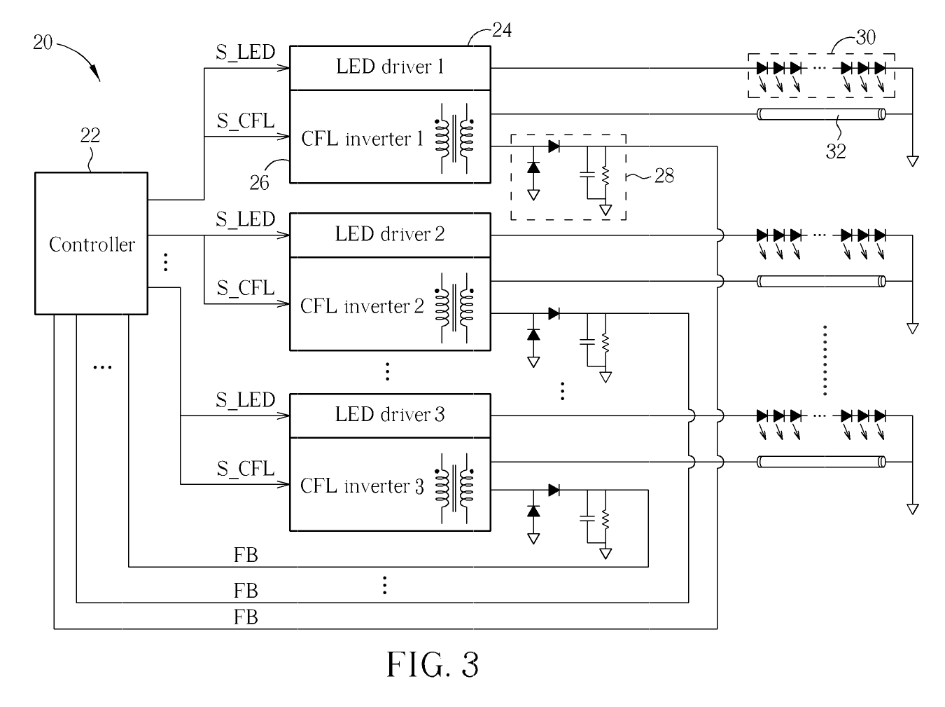

Please refer to FIG. 3. FIG. 3 is a block diagram illustrating the backlight module 20 of the present invention. The backlight module 20 comprises a controller 22, an LED driver 24, a lamp inverter 26, a feedback circuit 28, an LED module 30 and a fluorescent lamp 32. The backlight module 20 of the present invention comprises two light sources. The first light source is the fluorescent lamp 32 and the second light source is the LED module 30. When the backlight module 20 is applied to the scanning backlight of an LCD, the controller 22 generates a first control signal S_CFL and a second control signal S_LED. The lamp inverter 26 drives the fluorescent lamp 32 according to the first control signal S_CFL. The LED driver 24 drives the LED module 30 according to the second control signal S_LED. The feedback circuit 28 is electrically connected between the lamp inverter 26 and the controller 22. The controller 22 adjusts the first control signal S_CFL according to the feedback signal FB generated by the feedback circuit 28, for stabilizing the operation of driving the fluorescent lamp 32. The LED module 30 is installed close to the fluorescent lamp 32, for improving the luminance response of the fluorescent lamp 32 when the fluorescent lamp is turned on and turned off. Due to the relative slow luminance response time of the fluorescent lamp 32, the effect of utilizing the black frame insertion to improve the motion blur is limited. Therefore, the backlight module 20 of the present invention utilizes the LED module 30 to compensate the luminance of the fluorescent lamp 32, so that the waveform of the luminance response of the backlight module 20 can be similar to a square wave. By utilizing the LED module 30 to compensate the luminance response of the fluorescent lamp 32, the motion blur can be improved by the black frame insertion method with more efficiency. The luminance of the original scanning backlight module can also be preserved.

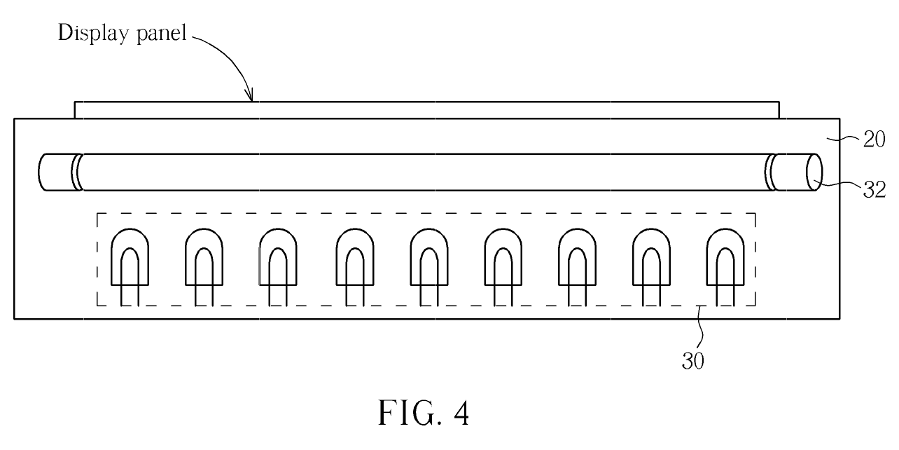

Please refer to FIG. 4. FIG. 4 is a diagram illustrating the location of the fluorescent lamp 32 and the LED module 30 in the backlight module 20. The backlight module 20 is installed as a light source under the display panel of an LCD. The fluorescent lamp 32 is the main light source of the backlight module 20. The LED module 30 is installed below the fluorescent lamp 32 for compensating the luminance of the fluorescent lamp 32. Since the luminance response time of the fluorescent lamp 32 is relatively long, a period of time is required for the fluorescent lamp 32 to reach the stable luminance after turning on the fluorescent lamp 32. Likewise, when the fluorescent lamp 32 is turned off, a period of time is required for the fluorescent lamp 32 to be completely darkened. In contrast to the fluorescent lamp 32, the luminance response of the LED module 30 is relatively instant. Therefore, the backlight module 20 of the present invention turns on the LED module 30 when the fluorescent lamp 32 is turned on, and the LED module 30 is turned off when the fluorescent lamp 32 has reached the stable luminance. On the other hand, the backlight module 20 of the present invention turns on the Led module 30 when the fluorescent lamp 32 is turned off and the LED module 30 is turned off when the fluorescent lamp 32 is completely darken. By utilizing the LED module 30 to compensate the luminance response of the fluorescent lamp 32, the backlight module 20 of the present invention can effectively improve the motion blur issue and preventing the issue of luminance deficiency when applied to the scanning backlight module of an LCD.

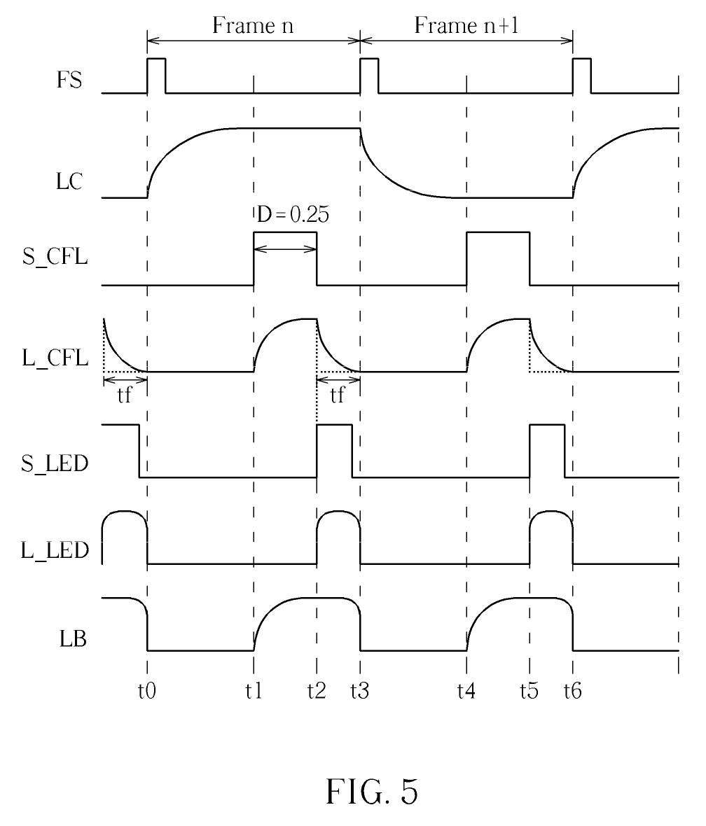

Please refer to FIG. 5. FIG. 5 is a waveform diagram illustrating the control signals of the first embodiment of the backlight module 20 of the present invention. The waveform FS represents the frame signal of the LCD. The waveform LC represents the response curve of the liquid crystals. The waveform S_CFL represents the control signal of the fluorescent lamp 32. The waveform L_CFL represents the luminance response curve of the fluorescent lamp 32. The waveform S_LED represents the control signal of the LED module 30. The waveform L_LED represents the luminance response curve of the LED module 30. The waveform LB represents the luminance response curve of the backlight module. In the first embodiment of the present invention, LED module 30 is utilized to improve the luminance response of the fluorescent lamp 32 when the fluorescent lamp 32 is turned off. For the controller 22 to turn off the backlight module 20 at the moment t3 according to the display signal, the controller 22 turns off the fluorescent lamp 32 in advance at the moment t2 (Due to the relatively long response time of the fluorescent lamp) and turns on the LED module 30 simultaneously. The luminance of the fluorescent lamp 32 is completely darkened after the luminance falling time tf of the fluorescent lamp 32 and the controller 22 then turns off the LED module 30. By utilizing the LED module 30 to compensate the luminance of the backlight module 20, the waveform of the luminance response of the backlight module 20, when the backlight module 20 is turning off, is similar to a square wave.

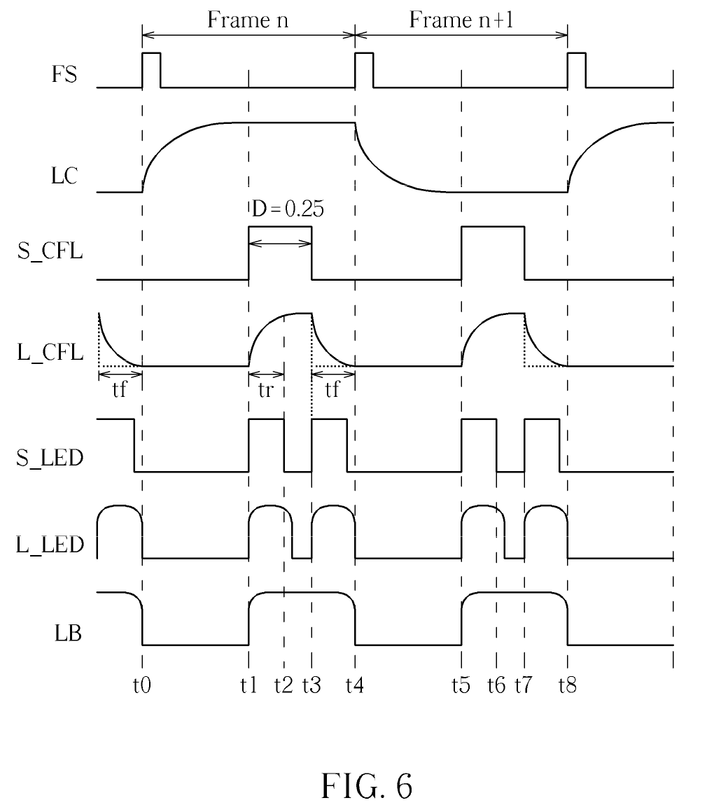

Please refer to FIG. 6. FIG. 6 is a waveform diagram illustrating the control signals of the second embodiment of the backlight module 20 of the present invention. In the second embodiment of the present invention, the LED module 30 is utilized to improve the luminance response of the fluorescent lamp 32 when the fluorescent lamp 32 is turned on and turned off. The controller 22 turns on the backlight module 20 at the moment t1 according to the display signal. The controller 22 also turns on the LED module 30 simultaneously. Due to the relatively slow response time of the fluorescent lamp 32, the luminance of the fluorescent lamp 32 reaches a stable level at the moment t2 after the period of luminance rising time tr. The controller 22 then turns off the LED module 30. Furthermore, the controller 22 turns off the backlight module 20 at the moment t4 according to the display signal. Due to the relatively long response time of the fluorescent lamp 32, the controller 22 turns off the fluorescent lamp 32 at the moment t3 and turns on the LED module 30 simultaneously. After the luminance falling time tf, the luminance of the fluorescent lamp 32 completely darkens at the moment t4. The controller 22 then turns off the LED module 30. Through the luminance compensation of the LED module 30, the backlight module can generate a waveform similar to a square wave. Therefore, the backlight module 20 of the present invention can effectively improve the issue of the slow luminance response of the fluorescent lamp 32. Furthermore, the backlight module 20 of the present invention enhances the effect of utilizing the black frame insertion to counter the motion blur issue, without sacrificing the luminance of the original scanning backlight module.

In conclusion, the backlight module of the present invention includes a first light source and a second light source. The luminance response time of the second light source is shorter than that of the first light source. Therefore the backlight module of the present invention utilizes the second light source to compensate the luminance of the first light source during the operation of turning on and off the first light source. According to the embodiments of the present invention, the backlight module of the present invention includes a fluorescent lamp, an LED module, a controller, a lamp inverter, and an LED driver. The controller generates a first control signal and a second control signal according to a display signal. The lamp inverter drives the fluorescent lamp according to the first control signal. The LED driver drives the LED module according to the second control signal. The LED module is installed close to the fluorescent lamp for compensating the luminance of the fluorescent lamp when being turned on and turned off. As a result, when applying to the scanning backlight of an LCD, the luminance waveform generated by the backlight module of the present invention resembles to a square wave, and improves the effect of improving the motion blur when utilizing the scanning backlight module of the LCD.

Those skilled in the art will readily observe that numerous modifications and alterations of the device and method may be made while retaining the teachings of the invention.

What is claimed is:

1. A backlight module, comprising:
a first light source;
a second light source, installed close to the first light source, for compensating a luminance of the first light source when the first light source is turned on and turned off;
a controller, for generating a first control signal and a second control signal according to a display signal;
a first light driver, electrically connected to the first light source, for driving the first light source according to the first control signal; and
a second light driver, electrically connected to the second light source, for driving the second light source according to the second control signal.

2. The backlight module of claim 1, wherein the first light source is a fluorescent lamp and the second light source is an LED module.

3. The backlight module of claim 1, wherein the first light driver is an LED driver and the second light driver is a lamp inverter.

4. The backlight module of claim 3, further comprising a feedback circuit, electrically connected between the lamp inverter and the controller.

5. The backlight module of claim 1, wherein the second light source is turned on when the first light source is turned on and the second light source is turned off when the luminance of the first light source is stabilized.

6. The backlight module of claim 1, wherein the second light source is turned on the when the first light source is turned off and the second light source is turned off when the luminance of the first light source is completely darkened.

7. The backlight module of claim 1, wherein a luminance response time of the second light source is shorter than a luminance response time of the first light source.

8. The backlight module of claim 1, wherein a luminance response time of the first light source is approximately 3 milliseconds.

9. The backlight module of claim 1, wherein a luminance response time of the second light source is approximately 1 microsecond.

10. The backlight module of claim 1, wherein the backlight module is utilized in a scanning backlight module of an LCD.
